(19) United States
(12) Patent Application Publication
(10) Pub. No.: US 2025/0026443 A1
(43) Pub. Date: Jan. 23, 2025

(54) Engine Cooling Systems for Snowmobiles

(71) Applicant: Arctic Cat Inc., Thief River Falls, MN (US)

(72) Inventors: Guy L. Sibilleau, Roseau, MN (US); Benjamin Nickolas Mercure, Thief River Falls, MN (US); Christian Ressler, Thief River Falls, MN (US)

(73) Assignee: Arctic Cat Inc., Thief River Falls, MN (US)

(21) Appl. No.: 18/666,651

(22) Filed: May 16, 2024

Related U.S. Application Data
(60) Provisional application No. 63/537,179, filed on Sep. 7, 2023.
(60) Provisional application No. 63/528,411, filed on Jul. 23, 2023.

(51) Int. Cl. B62M 27/02; B62J 41/00

(52) U.S. Cl. CPC B62M 27/02; B62J 41/00; B62M 2027/023; B62M 2027/028

(57) ABSTRACT

An engine cooling system for a snowmobile that includes a forward frame assembly, an engine, a tunnel and a track driveshaft having an axis of rotation. The cooling system includes a heat exchanger that is coupled to the forward frame assembly and to the tunnel. The heat exchanger is positioned aft of the engine and is configured to transfer heat from a coolant fluid circulated through the engine and the heat exchanger. The heat exchanger includes a body having an arcuate section with a substantially constant radius of curvature and with a center of curvature proximate the axis of rotation of the track driveshaft.

### CROSS-REFERENCE TO RELATED APPLICATIONS

The present application claims the benefit of U.S. Provisional Application No. 63/528,411, filed Jul. 23, 2023 and U.S. Provisional Application No. 63/537,179, filed Sep. 7, 2023, the entire contents of each is hereby incorporated by reference.

### TECHNICAL FIELD OF THE DISCLOSURE

The present disclosure relates, in general, to engine cooling systems for use on land vehicles and, in particular, to engine cooling systems for use on snowmobiles that include a heat exchanger having a body with an arcuate section that expands the engine bay to accommodate a larger four-stroke engine in a chassis designed for a two-stroke engine.

### BACKGROUND

Snowmobiles are popular land vehicles used for transportation and recreation in cold and snowy conditions. Certain snowmobiles are designed for specific applications such as trail, utility, mountain, race and crossover applications, to name a few. Snowmobiles typically include a chassis that supports various components of the snowmobile such as an engine, a transmission and a ground-engaging endless drive track disposed in a longitudinally extending tunnel. The engine and transmission power the drive track to enable ground propulsion for the vehicle. A rider controls the operation of the snowmobile using a steering system including a handlebar assembly that is operatively linked to a pair of ski assemblies that provide flotation for the front of the snowmobile over the snow.

The engine used in snowmobiles is typically a naturally aspirated internal combustion engine. For example, some snowmobiles utilize a two-stroke internal combustion engine due to the compact size, efficient design and high power-to-weight ratio of such engines. Other snowmobiles utilize a four-stroke internal combustion engine due to the high fuel efficiency, low noise, reduced emissions and simplified refueling process. To increase the power output of a snowmobile without increasing the size of the engine, certain snowmobiles add a forced induction system to the engine such as a turbocharger. Snowmobile engines are typically cooled by circulating a coolant through an engine cooling system that receives warmed coolant from the engine, passes the warmed coolant through one or more heat exchangers to remove heat and then returns cooled coolant back to engine, thereby forming a cooling circuit. One type of heat exchanger found on snowmobiles is a radiator that cools the circulating coolant with air passing therethrough. Another type of heat exchanger found on snowmobiles is a tunnel heat exchanger that cools the circulating coolant due to snow present in the tunnel during snowmobile operations.

### SUMMARY

In a first aspect, the present disclosure is directed to an engine cooling system for a snowmobile that has a forward frame assembly, an engine cooled by a fluid, a tunnel and a track driveshaft having an axis of rotation. The cooling system includes a radiator, a heat exchanger and a tunnel heat exchanger. The radiator is coupled to the forward frame assembly and is positioned forward of the engine. The radiator is configured to remove heat from the fluid responsive to air passing therethrough. The heat exchanger is coupled to a forward portion of the tunnel and is positioned aft of the engine. The heat exchanger is configured to remove heat from the fluid responsive to snow in the tunnel. The heat exchanger has a substantially constant radius of curvature with a center of curvature proximate the axis of rotation of the track driveshaft. The tunnel heat exchanger is positioned along a top portion of the tunnel. The tunnel heat exchanger is configured to remove heat from the fluid responsive to snow in the tunnel. The radiator, the heat exchanger and the tunnel heat exchanger are in fluid communication with the engine forming a cooling circuit through which the fluid circulates such that heat extracted from the engine by the fluid is removed from the fluid in the cooling circuit as the fluid circulates therethrough.

In some embodiments, the radiator may be positioned above and coupled to a nose portion of the forward frame assembly. In certain embodiments, the radiator may be tilted forward such that an upper portion of the radiator is forward of a lower portion of the radiator. In some embodiments, the heat exchanger may have a forward apex, an upper arcuate section extending upward and aftward from the forward apex and a lower arcuate section extending downward and aftward from the forward apex. In such embodiments, the upper arcuate section may have a distal end that is coupled to the forward portion of the tunnel. Also, in such embodiments, the lower arcuate section may have a distal end that includes a snow retaining fin extending therefrom wherein, the snow retaining fin may have a positive snow retention angle configured to enhance a dwell time of snow thereon. In certain embodiments, the lower arcuate section may have an inner surface including a plurality of snow retaining fins extending therefrom wherein, each of the snow retaining fins may have a positive snow retention angle configured to enhance the dwell time of snow thereon. In some embodiments, the lower arcuate section may have an inner surface including a plurality of snow retaining fins extending therefrom wherein, the snow retaining fins having progressively increasing positive snow retention angles from an upper snow retaining fin to a lower snow retaining fin with each of the snow retaining fins configured to enhance the dwell time of snow thereon. In certain embodiments, the lower arcuate section and a lower portion of the upper arcuate section may have an inner surface including a plurality of snow retaining fins extending therefrom wherein, each of the snow retaining fins may have a positive snow retention angle configured to enhance the dwell time of snow thereon. In some embodiments, the heat exchanger may have an inner surface including a plurality of snow retaining fins extending therefrom wherein, at least some of the snow retaining fins have a positive snow retention angle configured to enhance the dwell time of snow thereon. In certain embodiments, the heat exchanger may have an inner surface including a plurality of snow retaining fins extending therefrom wherein, the snow retaining fins having progressively increasing snow retention angles from an upper snow retaining fin to a lower snow retaining fin.

In some embodiments, the tunnel heat exchanger may include a longitudinally extending outbound channel and a longitudinally extending inbound channel that are substantially parallel with each other. In certain embodiments, the tunnel heat exchanger may extend substantial the entire length of the tunnel. In other embodiments, the tunnel heat exchanger may extend only a portion of the length of the tunnel. In some embodiments, the radiator may be fluidically positioned between the engine and the heat exchanger, the heat exchanger may be fluidically positioned between the radiator and the tunnel heat exchanger, the tunnel heat exchanger may be fluidically positioned between the heat exchanger and the engine, and the engine may be fluidically positioned between the tunnel heat exchanger and the radiator. In certain embodiments, the radiator may be coupled between the engine and the heat exchanger, the heat exchanger may be coupled between the radiator and the tunnel heat exchanger, the tunnel heat exchanger may be coupled between the heat exchanger and the engine, and the engine may be coupled between the tunnel heat exchanger and the radiator. In some embodiments, the fluid may circulate through the cooling circuit sequentially from the radiator to the heat exchanger then to the tunnel heat exchanger. In certain embodiments, the cooling system may include an expansion chamber fluidically positioned between the tunnel heat exchanger and the engine. In certain embodiments, the cooling system may include a thermostat and a bypass system wherein, the thermostat is configured to monitor a temperature of the fluid and regulate fluid flow between the bypass system and the cooling circuit.

In a second aspect, the present disclosure is directed to a snowmobile including a forward frame assembly, a tunnel coupled to the forward frame assembly, a powertrain coupled to the forward frame assembly and including an engine cooled by a fluid, and a drive track system disposed at least partially below the tunnel. The drive track system includes a track driveshaft having an axis of rotation. The track driveshaft receives rotational energy from the powertrain such that the drive track system is configured to provide ground propulsion for the snowmobile. A radiator is coupled to the forward frame assembly and is positioned forward of the engine. The radiator is configured to remove heat from the fluid responsive to air passing therethrough. A heat exchanger is coupled to a forward portion of the tunnel and is positioned aft of the engine. The heat exchanger is configured to remove heat from the fluid responsive to snow in the tunnel. The heat exchanger has a substantially constant radius of curvature with a center of curvature proximate the axis of rotation of the track driveshaft. A tunnel heat exchanger is positioned along a top portion of the tunnel. The tunnel heat exchanger is configured to remove heat from the fluid responsive to snow in the tunnel. The radiator, the heat exchanger and the tunnel heat exchanger are in fluid communication with the engine forming a cooling circuit through which the fluid circulates such that heat extracted from the engine by the fluid is removed from the fluid in the cooling circuit as the fluid circulates therethrough.

In a third aspect, the present disclosure is directed to a snowmobile including a tunnel and a drive track system that is at least partially disposed within the tunnel. The drive track system includes a track driveshaft having an axis of rotation. A heat exchanger is coupled to a forward end of the tunnel. The heat exchanger includes a substantially constant radius of curvature with respect to the axis of rotation of the track driveshaft.

In some embodiments, a forward frame assembly may be coupled to the tunnel and an engine may be coupled to the forward frame assembly. The engine may be aftwardly tilted and may include a crankshaft having an axis of rotation. In certain embodiments, the engine may include a pump that is in fluid communication with a fluid inlet port positioned on a forward side of the engine. In some embodiments, the engine may include an exhaust outlet positioned on the forward side of the engine and an air intake inlet positioned on an aftward side of the engine. In certain embodiments, the engine may include an oil sump positioned below the crankshaft. In some embodiments, the pump may be positioned forward of the axis of rotation of the crankshaft. In certain embodiments, an air plenum may be positioned on top of the engine.

In a fourth aspect, the present disclosure is directed to an engine cooling system for a snowmobile that including a forward frame assembly, an engine, a tunnel and a track driveshaft having an axis of rotation. The cooling system includes a heat exchanger that is coupled to the forward frame assembly and to the tunnel. The heat exchanger is positioned aft of the engine and is configured to transfer heat from a coolant fluid circulated through the engine and the heat exchanger. The heat exchanger includes a body having an arcuate section with a substantially constant radius of curvature and with a center of curvature proximate the axis of rotation of the track driveshaft.

In some embodiments, the body may have a forward wall, an aft wall, an upper end and a lower end with the forward and aft walls each having a forward apex. In certain embodiments, the arcuate section may include an upper portion that extends upward and aftward from the forward apexes and a lower portion that extends downward and aftward from the forward apexes. In some embodiments, the upper end may be coupled to the tunnel and the lower end may be coupled to the forward frame assembly. In certain embodiments, the lower end may be positioned aft of the forward apex of the aft wall. In some embodiments, the heat exchanger may include an engine mounting assembly positioned on the forward wall at a location that is closer to the upper end than to the lower end. In such embodiments, the arcuate section of the body may extend from the lower end to at least the engine mounting assembly. In certain embodiments, the heat exchanger may include a lowermost chamber disposed within the lower portion of the arcuate section and a fluid port that is positioned on the forward wall and is in fluid communication with the lowermost chamber. In such embodiments, the fluid port may extend forward and downward from the forward wall.

In a fifth aspect, the present disclosure is directed to a snowmobile including a forward frame assembly, a tunnel coupled to the forward frame assembly and a drive track system disposed at least partially below the tunnel and including a track driveshaft having an axis of rotation. A heat exchanger has a body with a forward wall, an aft wall, an upper end and a lower end. The upper end is coupled to the tunnel and the lower end is coupled to the forward frame assembly. The heat exchanger includes an engine mounting assembly positioned on the forward wall between the upper and lower ends. The body has an arcuate section with a substantially constant radius of curvature and with a center of curvature proximate the axis of rotation of the track driveshaft. The arcuate section extends from the lower end of the body to at least the engine mounting assembly.

In some embodiments, the heat exchanger may define at least first and second chambers with a partition therebetween that extends between the forward wall and the aft wall behind the engine mounting assembly. In certain embodiments, the body may include an upper housing that defines the first and second chambers with the engine mounting assembly integrally formed with the upper housing. In some embodiments, the body may have a length in the lateral direction of the snowmobile and the engine mounting assembly may include mounting rails that have a length in the lateral direction of the snowmobile that is more than half the length of the body. In certain embodiments, a vibration damper having a mount axis that extends through the body may be coupled to the engine mounting assembly. In such embodiments, the arcuate section of the body may extend from the lower end of the body to at least the mount axis of the vibration damper. Also, in such embodiments, the mount axis of the vibration damper may extend in a radial direction of the track driveshaft.

In a sixth aspect, the present disclosure is directed to a snowmobile including a forward frame assembly, a tunnel coupled to the forward frame assembly and a drive track system disposed at least partially below the tunnel and including a track driveshaft having an axis of rotation. A heat exchanger has a body including an upper housing with an upper end and a lower housing with a lower end. The upper end is coupled to the tunnel and the lower end is coupled to the forward frame assembly. The heat exchanger includes an engine mounting assembly positioned on a forward side of the upper housing and a fluid port positioned on a forward side of the lower housing. The body has an arcuate section with a substantially constant radius of curvature and a center of curvature proximate the axis of rotation of the track driveshaft. The arcuate section extends at least between the fluid port and the engine mounting assembly.

In some embodiments, the upper housing may have a forward wall having a first thickness and the lower housing may have a forward wall having a second thickness that is less than the first thickness. In certain embodiments, the body may have a forward apex, the upper end may be positioned aft and above the forward apex and/or the lower end may be positioned aft and below the forward apex. In some embodiments, the forward apex may be located on the lower housing. In certain embodiments, a vibration damper may be coupled to the engine mounting assembly such that the vibration damper is positioned aft of a plane that is tangent to the forward apex. In some embodiments, the lower end may be positioned aft at least a portion of the vibration damper. In certain embodiments, a vibration damper having a mount axis that extends through the body may be coupled to the engine mounting assembly. In such embodiments, the arcuate section of the body may extend at least between the fluid port and the mount axis of the vibration damper.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1E are schematic illustrations of a snowmobile having an engine cooling system in accordance with embodiments of the present disclosure;

FIGS. 2A-2B are isometric views of an engine cooling system for a snowmobile in accordance with embodiments of the present disclosure;

FIG. 3 is an isometric view of an engine cooling system for a snowmobile in accordance with embodiments of the present disclosure;

FIGS. 4A-4B are side views of a forward portion of the tunnel including a heat exchanger and a tunnel heat exchanger of an engine cooling system for a snowmobile in accordance with embodiments of the present disclosure;

FIGS. 5A-5B are rear elevation and cross sectional views of a heat exchanger of an engine cooling system for a snowmobile in accordance with embodiments of the present disclosure; and

FIGS. 6A-6D are various views of a heat exchanger including an engine mounting system for a snowmobile in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

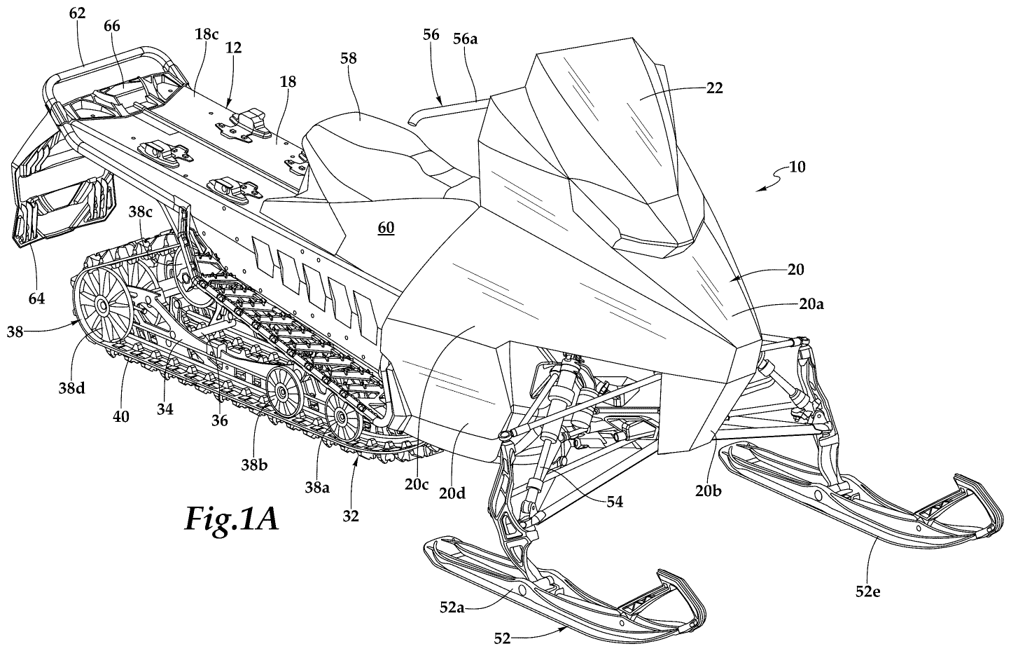

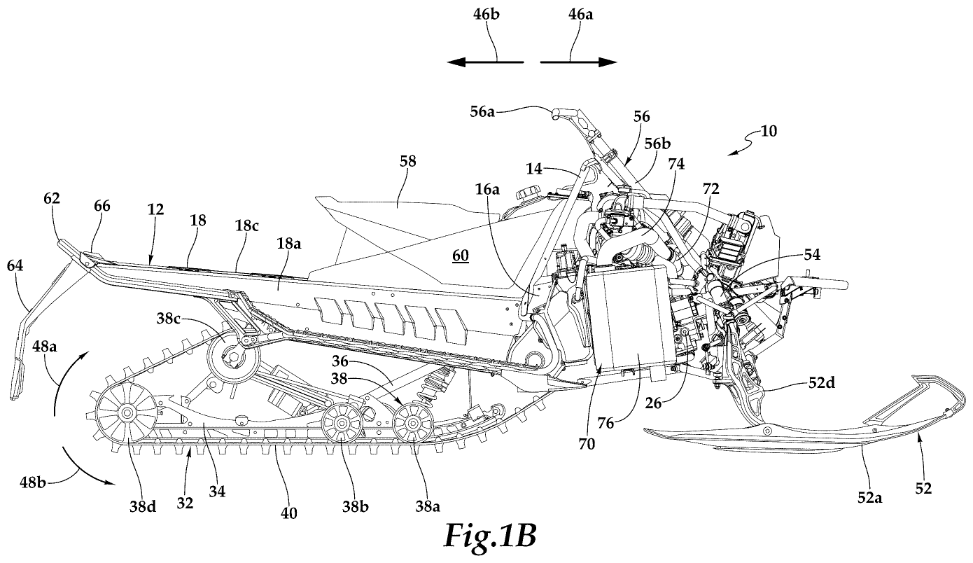

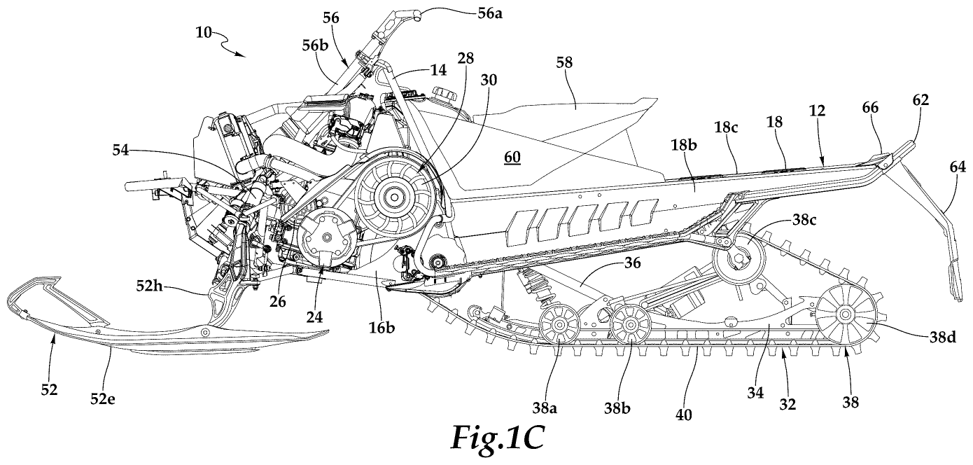

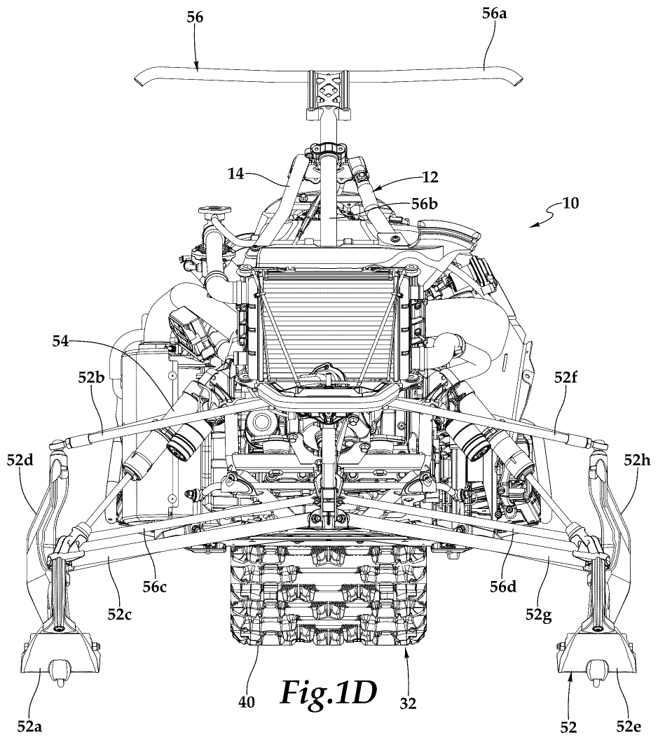

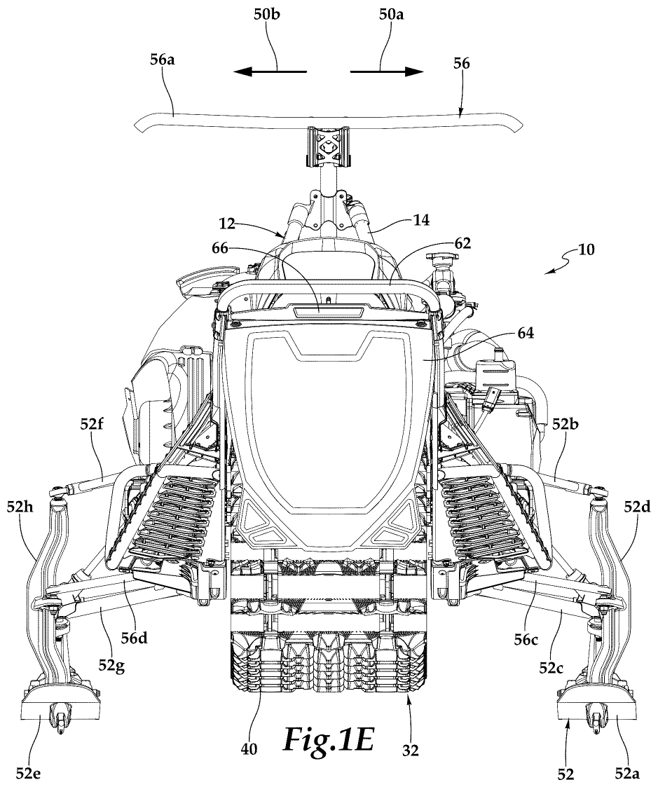

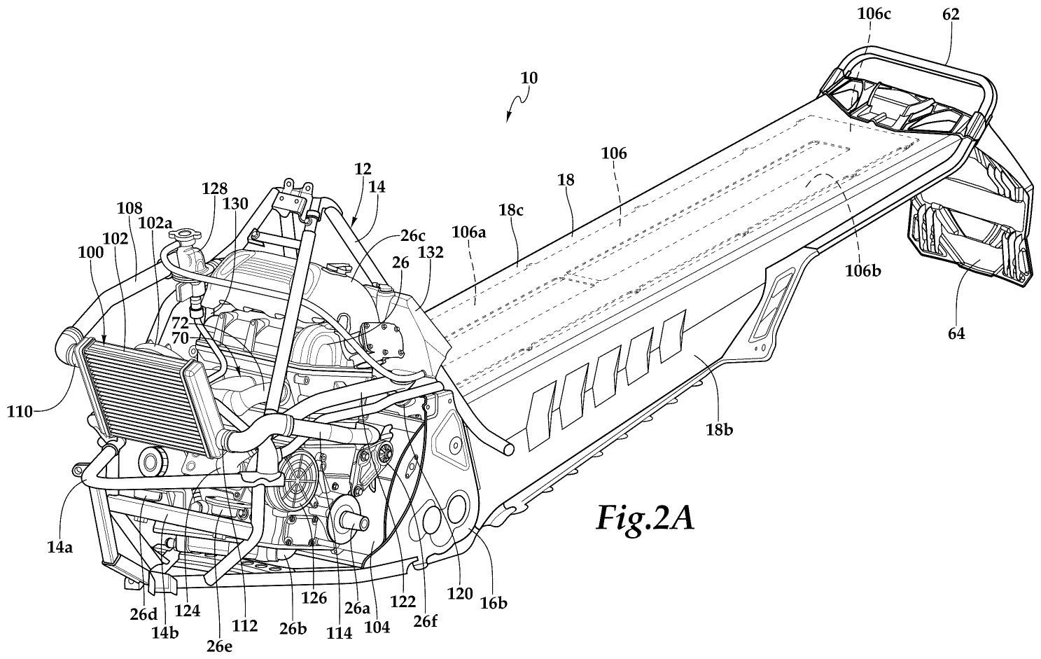

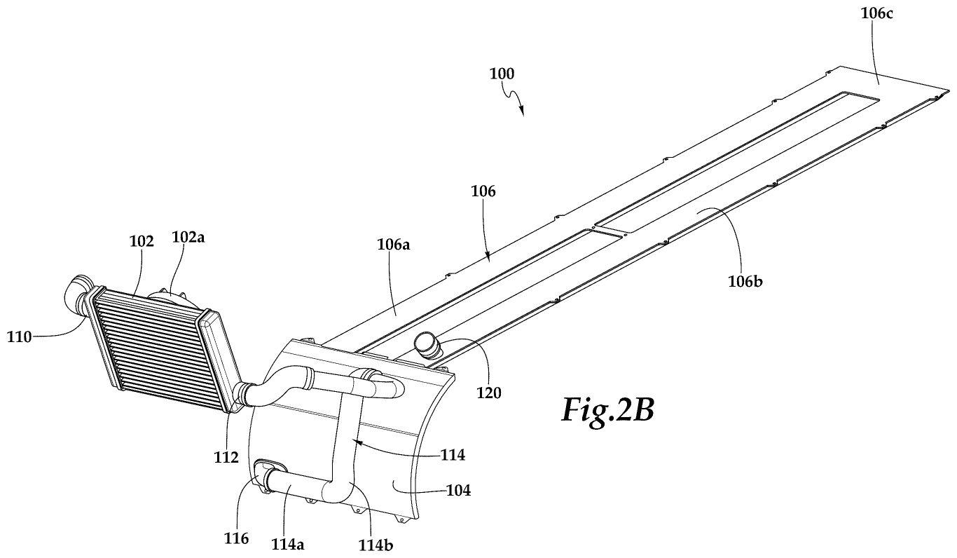

Referring to FIGS. 1A-1E in the drawings, a land vehicle depicted as a snowmobile is schematically illustrated and generally designated 10. Structural support for snowmobile 10 is provided by a chassis 12 that includes a forward frame assembly 14 and a longitudinally extending tunnel 18. In the illustrated embodiment, forward frame assembly 14 (see also FIG. 2A) is formed from interconnected tubular members such as round and hollow tubular members comprised of metal, metal alloy, polymeric materials, fiber reinforced polymer composites and/or combinations thereof that are coupled together by welds, bolts, pins or other suitable fastening means. A right plate member 16a and a left plate member 16b may be coupled to and preferably welded to forward frame assembly 14 such that forward frame assembly 14 and plate members 16a, 16b form a welded frame assembly. Tunnel 18 is coupled to forward frame assembly 14 and/or plate members 16a, 16b with welds, bolts, rivets or other suitable means. In the illustrated embodiment, tunnel 18 includes a right sidewall 18a, a left sidewall 18b and a top panel 18c. Tunnel 18 may be integrally formed or may consist of multiple members that are coupled together with welds, bolts, rivets or other suitable means. Plate members 16a, 16b and tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

Body panels 20 have been removed from snowmobile 10 in FIGS. 1B-1E to reveal the underlying components of snowmobile 10. For example, snowmobile 10 has a powertrain 24 that includes an engine 26 and a drivetrain 28 both of which are coupled to forward frame assembly 14. Engine 26 resides in an engine bay formed within forward frame assembly 14. In the illustrated embodiment, engine 26 is a four-stoke, three cylinder internal combustion engine such as a naturally aspirated internal combustion engine or a forced induction internal combustion engine that includes, for example, one or more turbochargers and/or superchargers that is aftwardly tilted and has air intake inlets on the aftward side of engine 26 and exhaust outlets on the forward side of engine 26. In other embodiments, an engine of the present disclosure may be a two-stroke engine, an electric motor, a hybrid engine or other prime mover. In addition, an engine of the present disclosure may have more than or less than three cylinders, may be vertically mounted or mounted with a forward tilt and/or may have air intake inlets or exhaust outlets in other locations. In one example, engine 26 may be an engine of the type disclosed in co-owned U.S. patent application 63/468,357, filed May 23, 2023, the entire contents of which is hereby incorporated by referenced. Engine 26 includes a crankshaft 26a (see also FIG. 2A) that has an axis of rotation. Crankshaft 26a is coupled to drivetrain 28 and specifically to a transmission 30 of drivetrain 28 such as a continuously variable transmission, an electrically variable transmission or other suitable transmission type for varying the ratio of the engine output speed to the drive track input speed. Engine 26 includes an oil sump 26b positioned below crankshaft 26a. Engine 26 has an air intake system that includes an air plenum 26c positioned on top of engine 26. In the illustrated embodiment, engine 26 is supported by forward frame assembly 14 and a heat exchanger 104 (see also FIG. 2A). More specifically, a right forward engine mount 26d and a left forward engine mount 26e couple engine 26 to a cross member 14b of forward frame assembly 14. In addition, a right aftward engine mount (not visible) and a left aftward engine mount 26f couple engine 26 to heat exchanger 104 via mounting brackets or mounting rails that are integral with and/or coupled to a forward wall of heat exchanger 104.

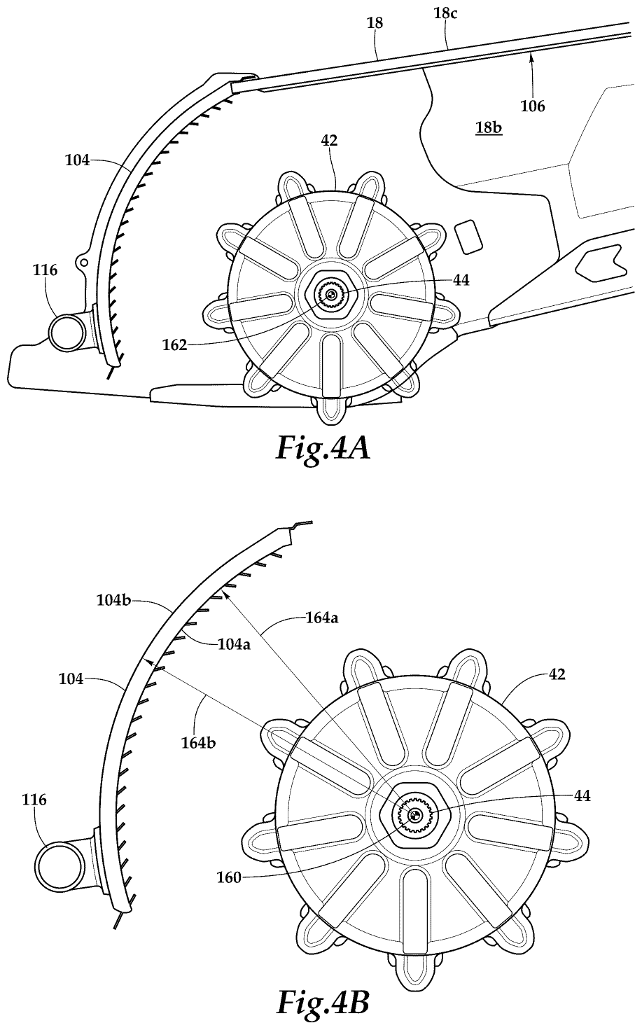

A drive track system 32 is at least partially disposed within and/or below tunnel 18 and is in contact with the ground to provide ground propulsion for snowmobile 10. Torque and rotational energy are provided to drive track system 32 from engine 26 via drivetrain 28. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket 42 via a track driveshaft 44 (see also FIGS. 4A-4B) that is rotated responsive to torque provided from powertrain 24. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1E. The backward direction may also be referred to herein as the aftward direction.

Snowmobile 10 has a ski system 52 and a front suspension assembly 54 that provide front end support for snowmobile 10. Ski system 52 includes a right ski 52a that is coupled to forward frame assembly 14 by upper and lower A-arms 52b, 52c and right spindle 52d. Ski system 52 also includes a left ski 52e that is coupled to forward frame assembly 14 by upper and lower A-arms 52f, 52g and left spindle 52h. Skis 52a, 52e are interconnected to a steering system 56 including a handlebar assembly 56a, a steering column 56b, a right tie rod 56c and a left tie rod 56d that enable the rider to steer snowmobile 10. For example, when handlebar assembly 56a is rotated, skis 52a, 52e responsively pivot to turn snowmobile 10. The rider controls snowmobile 10 from a seat 58 that is position atop a fuel tank 60, above tunnel 18, aft of handlebar assembly 56a and aft of forward frame assembly 14. Snowmobile 10 has a lift bumper 62 that is coupled to an aft end of tunnel 18 that enables a person to lift the rear end of snowmobile 10 in the event snowmobile 10 becomes stuck or needs to be repositioned when it is not moving. Snowmobile 10 has a snow flap 64 that deflects snow emitted by endless track 40. In the illustrated embodiment, snow flap 64 is coupled to lift bumper 62. In other embodiments, a snow flap may be coupled directly to tunnel 18. A taillight housing 66 is also coupled to lift bumper 62 and houses a taillight of snowmobile 10. Snowmobile 10 has an exhaust system 70 that includes an exhaust manifold 72 that is coupled to engine 26, an exhaust duct 74 and a muffler 76. Exhaust system 70 is configured to direct high-temperature exhaust gases away from engine 26 and the rider of snowmobile 10. As exhaust system 70 including exhaust manifold 72 is coupled to the forward side of engine 26, the forward side of engine 26 may be referred to herein as the hot side of engine 26 due to the hot temperatures associated with engine exhaust. The aftward side of engine 26 is concomitantly considered the cool side of engine 26 as hot exhaust system components are located opposite and/or remote therefrom.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

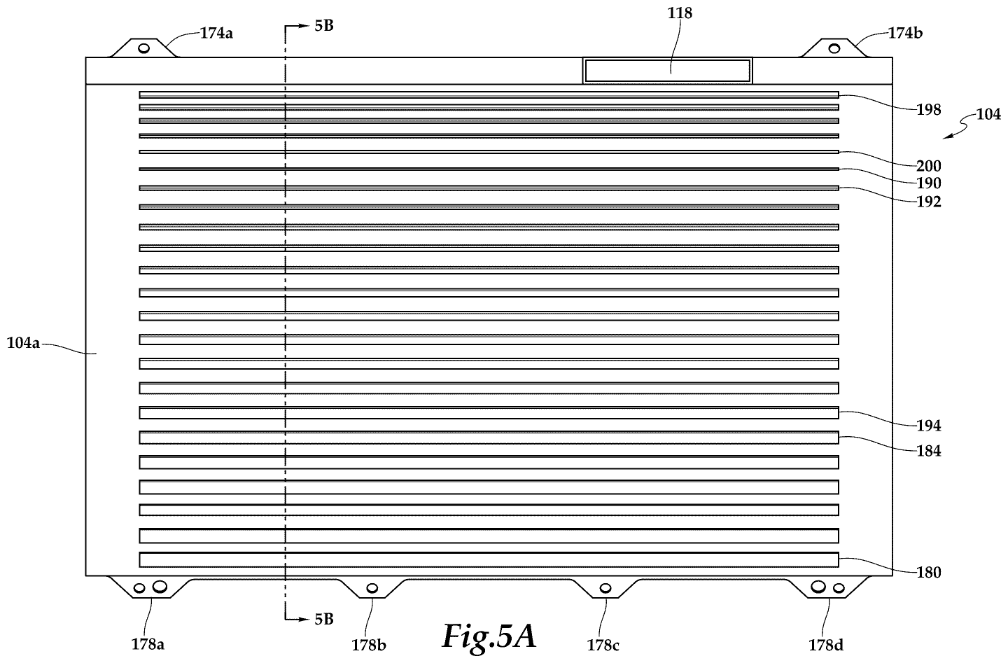

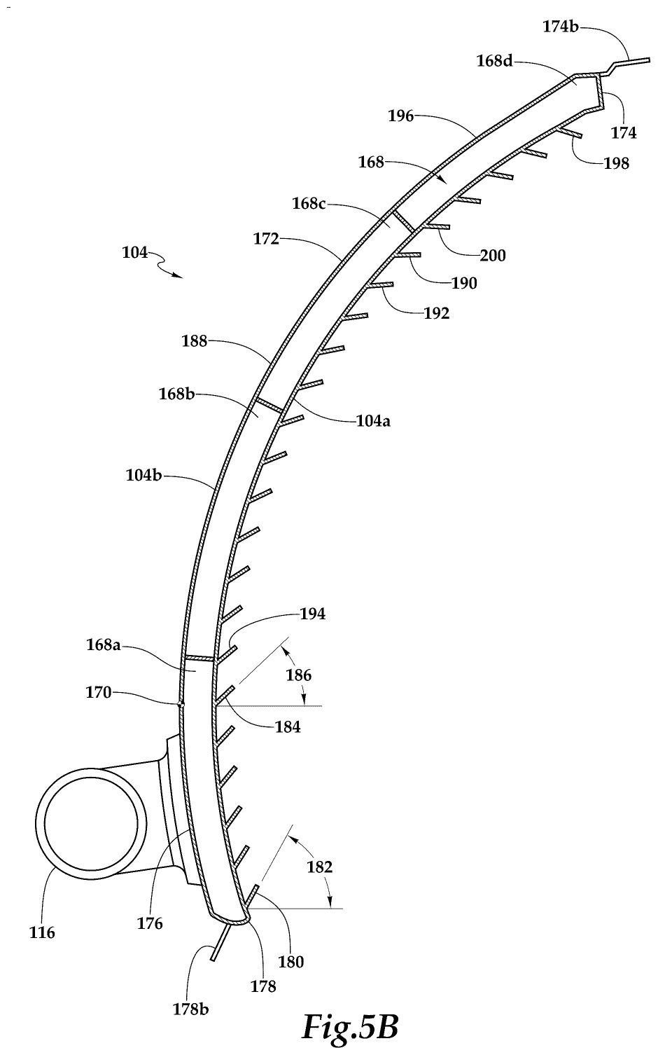

Referring additionally to FIGS. 2A-2B of the drawings, details of an engine cooling system 100 of snowmobile 10 will now be discussed. In the illustrated embodiment, engine cooling system 100 includes a radiator 102 that is coupled to forward frame assembly 14. In other embodiments, an engine cooling system for a snowmobile may not include a radiator, may have an intercooler instead of a radiator or may have both a radiator and an intercooler. In the illustrated embodiment, radiator 102 is coupled to and positioned above a nose portion 14a of forward frame assembly 14. In this location, radiator 102 is positioned forward of engine 26 and is tilted forward such that an upper portion of radiator 102 is forward of a lower portion of radiator 102. Radiator 102 is configured to remove heat from a coolant fluid circulating therethrough responsive to air passing through radiator 102 from the front side of radiator 102 to the rear side of radiator 102. In the illustrated embodiment, radiator 102 includes a fan 102a that may be selectively operated to help air move through radiator 102. Engine cooling system 100 also includes heat exchanger 104. An upper end of heat exchanger 104 is coupled to a forward portion of tunnel 18, the end caps of heat exchanger 104 are coupled to plate members 16a, 16b and a lower end of heat exchanger 104 is coupled to forward frame assembly 14 via a cross member of a belly pan. In this location, heat exchanger 104 is positioned aft of engine 26. Heat exchanger 104 is configured to remove heat from a coolant fluid circulating therethrough responsive to snow in tunnel 18. For example, during operation of snowmobile 10, endless track 40 kicks snow toward an inner surface 104a (see FIG. 5A) of heat exchanger 104 which is configured to retain at least a portion of this snow. Heat from the coolant fluid circulating through heat exchanger 104 is transferred to the retained snow causing the retained snow to melt. Engine cooling system 100 further includes a tunnel heat exchanger 106 that is positioned along a top portion of tunnel 18. Tunnel heat exchanger 106 is configured to remove heat from a coolant fluid circulating therethrough responsive to snow in tunnel 18. For example, during operation of snowmobile 10, endless track 40 kicks snow toward an upper surface of tunnel 18, a portion of which sticks to this surface which is in thermal communication with tunnel heat exchanger 106. Heat from the coolant fluid circulating through tunnel heat exchanger 106 is transferred to the retained snow causing the retained snow to melt. It is noted that snow flap 64 helps to retain snow in tunnel 18 which aids in the snow sticking to the upper surface of tunnel 18.

In the illustrated embodiment, radiator 102, heat exchanger 104 and tunnel heat exchanger 106 form a cooling circuit that is in fluid communication with engine 26. In other embodiments, a cooling circuit for engine 26 may include fewer, additional or different components such as a cooling circuit including only heat exchanger 104 and tunnel heat exchanger 106. In the illustrated embodiment, radiator 102 is fluidically positioned between engine 26 and heat exchanger 104. In addition, heat exchanger 104 is fluidically positioned between radiator 102 and tunnel heat exchanger 106. Also, tunnel heat exchanger 106 is fluidically positioned between heat exchanger 104 and engine 26. Finally, engine 26 is fluidically positioned between tunnel heat exchanger 106 and radiator 102. More specifically, radiator 102 is coupled engine 26 via a fluid discharge port on the aftward side (not visible) of engine 26, a fluid conduit 108 and a fluid inlet port 110 of radiator 102. Radiator 102 is also coupled to heat exchanger 104 via a fluid discharge port 112 of radiator 102, a fluid conduit 114 and a fluid inlet port 116 of heat exchanger 104. Heat exchanger 104 is coupled to tunnel heat exchanger 106 via a direct coupling of a fluid discharge port 118 (see FIG. 5A) of heat exchanger 104 and an inlet of a longitudinally extending outbound channel 106a of tunnel heat exchanger 106 which is in fluid communication with and substantially parallel with a longitudinally extending inbound channel 106b of tunnel heat exchanger 106. A laterally extending channel 106c fluidically couples outbound channel 106a and inbound channel 106b of tunnel heat exchanger 106. Tunnel heat exchanger 106 is coupled engine 26 via a fluid discharge port 120 of inbound channel 106b, a fluid conduit 122 and a fluid inlet port 124 on the forward side of engine 26. Fluid inlet port 124 is in fluid communication with a pump 126 that circulates the coolant fluid through engine 26 and the cooling circuit.

In the illustrated embodiment, fluid circulates through the cooling circuit sequentially from engine 26 to radiator 102 then to heat exchanger 104 then to tunnel heat exchanger 106 before returning to engine 26. More specifically, warmed fluid that has extracted heat from engine 26 exits engine 26 via the fluid discharge port (not visible) of engine 26 and flows to radiator 102 via fluid conduit 108 and fluid inlet port 110. The fluid then flows through radiator 102 as cool air passes through radiator 102 removing some of the heat from the fluid. The fluid now exits radiator 102 via fluid discharge port 112 and flows to heat exchanger 104 via fluid conduit 114 and fluid inlet port 116. It is noted that a portion of fluid conduit 114 and fluid inlet port 116 are positioned between heat exchanger 104 and engine 26 including a substantially horizontal section 114a and a substantially vertical section 114b of fluid conduit 114. The fluid then flows through multiple stages (see FIG. 5B) within heat exchanger 104 as snow retained on inner surface 104a is melted which removes some of the heat from the fluid. The fluid now exits heat exchanger 104 via fluid discharge port 118 (see FIG. 5A) and flows into tunnel heat exchanger 106 via the direct coupling. The fluid then flows through outbound channel 106a, laterally extending channel 106c and inbound channel 106b of tunnel heat exchanger 106 as snow retained on an upper surface of tunnel 18 is melted which removes some of the heat from the fluid. The cooled fluid now exits tunnel heat exchanger 106 via fluid discharge port 120 and returns to engine 26 via fluid conduit 122 and fluid inlet port 124. In this manner, heat from the warmed fluid from engine 26 is removed in the cooling circuit formed by radiator 102, heat exchanger 104 and tunnel heat exchanger 106.

In the illustrate embodiment, engine cooling system 100 includes a thermostat 128 that monitors the temperature of the fluid exiting engine 26 to determine whether the fluid should be circulated through the cooling circuit. If the temperature of the fluid is below a predetermined threshold, thermostat 128 signals a valve to remain closed such that the fluid exiting engine 26 bypasses the cooling circuit via bypass conduit 130 and returns directly to engine 26. If the temperature of the fluid is above a predetermined threshold, thermostat 128 signals the valve to open which routes the fluid exiting engine 26 to the cooling circuit for heat removal, as discussed herein. Also, in the illustrated embodiment, engine cooling system 100 includes an expansion chamber 132 that is fluidically positioned between tunnel heat exchanger 106 and engine 26.

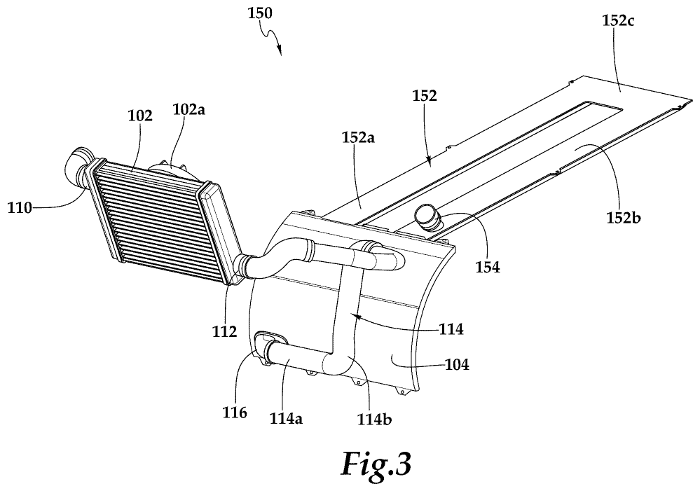

Even though tunnel heat exchanger 106 has been depicted and described as having longitudinally extending outbound channel 106a that is substantially parallel with longitudinally extending inbound channel 106b, each of which extends substantially the entire length of tunnel 18, it should be understood by those having ordinary skill in the art that a tunnel heat exchanger could have other configurations. For example, as best seen in FIG. 3, an engine cooling system 150 for snowmobile 10 has a cooling circuit that includes radiator 102, heat exchanger 104 and a tunnel heat exchanger 152. Similar to engine cooling system 100, in engine cooling system 150, fluid circulates through the cooling circuit sequentially from engine 26 to radiator 102 then to heat exchanger 104 then to tunnel heat exchanger 152 before returning to engine 26. Tunnel heat exchanger 152 has a longitudinally extending outbound channel 152a that is in fluid communication with and substantially parallel with a longitudinally extending inbound channel 152b that are fluidically coupled together by a laterally extending channel 152c. Inboard channel 152b has a fluid discharge port 154 that communicates fluid to engine 26. In the illustrated embodiment, however, longitudinally extending outbound channel 152a and longitudinally extending inbound channel 152b do not extend substantially the entire length of tunnel 18 but rather, extend only a portion of the length of tunnel 18 such as between about twenty-five percent and seventy-five percent of the length of tunnel 18 or between about thirty-three percent and sixty-six percent of the length of tunnel 18 such as about fifty percent of the length of tunnel 18.

Referring now to FIGS. 4A-4B of the drawings, certain details of heat exchanger 104 will now be discussed. In the illustrated embodiment, heat exchanger 104 is coupled to a forward portion of tunnel 18. Note that in FIG. 4A, the left end cap of heat exchanger 104, left sidewall 18a and most of drive track system 32 except for track drive sprocket 42 and track driveshaft 44 have been removed. In addition, only the body of heat exchanger 104 without the end caps, track drive sprocket 42 and track driveshaft 44 are presented in FIG. 4B. Heat exchanger 104 is positioned relative to track drive sprocket 42 such that heat exchanger 104 has a center of curvature 160 (see FIG. 4B) that is at least proximate to, and in the illustrated embodiment coincident with, an axis of rotation 162 (see FIG. 4A) of track driveshaft 44. In addition, inner surface 104a of heat exchanger 104 has a substantially constant radius of curvature 164a and outer surface 104b of heat exchanger 104 has a substantially constant radius of curvature 164b. Having substantially constant radii of curvature 164a, 164b and having center of curvature 160 coincident with axis of rotation 162 of track driveshaft 44 not only improves the snow receiving and retention functionality of heat exchanger 104 but also minimizes the space requirements of heat exchanger 104 which enlarges the engine bay. For example, the enlarged engine bay accommodates a larger four-stroke engine in a chassis designed for a two-stroke, allows the engine to be positioned lower in the engine bay which lowers the center of gravity of the snowmobile, allows the engine to have reduced aftward tilt and/or provides space for additional snowmobile components to be positioned between the engine and the lower portion of heat exchanger 104 such as fluid inlet port 116 and the substantially horizontal section 114a of fluid conduit 114 or an oil tank such as that disclosed in copending U.S. application Ser. No. 18/650,021 filed Apr. 29, 2024, the entire contents of which are hereby incorporated by reference.

Referring additionally to FIGS. 5A-5B of the drawings, further details of heat exchanger 104 will now be disclosed. In FIG. 5A, inner surface 104a of the body of heat exchanger 104 is revealed including fluid discharge port 118 that is directly coupled to the inlet of longitudinally extending outbound channel 106a of tunnel heat exchanger 106. In FIG. 5B, a cross section view of the body of heat exchanger 104 taken along line 5B-5B in FIG. 5A is presented. As best seen in FIG. 5B, heat exchanger 104 has a plurality of chambers 168 including a first or lowermost chamber 168a, a second chamber 168b, a third chamber 168c and a fourth or uppermost chamber 168d that function as heat exchanger stages. Fluid from fluid inlet port 116 enters first chamber 168a of heat exchanger 104 and travels laterally and upwardly through the first stage before entering second chamber 168b in which the fluid travels laterally and upwardly through the second stage before entering third chamber 168c in which the fluid travels laterally and upwardly through the third stage before entering fourth chamber 168d in which the fluid travels laterally and upwardly through the fourth stage before exiting fluid discharge port 118 and entering tunnel heat exchanger 106. Even though heat exchanger 104 has been depicted and described as having a particular number of chambers and stages, it should be understood by those having ordinary skill in the art that a heat exchanger of the present disclosure could have other numbers of chambers and stages either less than or greater than four.

In the illustrated embodiment, heat exchanger 104 has a forward apex 170 that is located adjacent to first chamber 168a which represents the forwardmost point of the cooling portion of heat exchanger 104. In other embodiments, a forward apex of a heat exchanger of the present disclosure could be located adjacent to another chamber such as second chamber 168b. Heat exchanger 104 includes an upper arcuate section 172 that extends upward and aftward from forward apex 170. Upper arcuate section 172 has a distal end 174 that is coupled to the forward portion of tunnel 18 such as by coupling tabs 174a, 174b to tunnel 18 using bolts, rivet or other suitable fastening means. Heat exchanger 104 also includes a lower arcuate section 176 extending downward and aftward from forward apex 170. Lower arcuate section 176 has a distal end 178 that is coupled to forward frame assembly 14 such as by coupling tabs 178a, 178b, 178c, 178d to a cross member of a belly pan of forward frame assembly 14 using bolts, rivet or other suitable fastening means. Distal end 178 of lower arcuate section 176 includes a snow retaining fin 180 that extends upward and aftward from inner surface 104a of heat exchanger 104. Snow retaining fin 180 has a positive snow retention angle such that snow kicked up by endless track 40 is captured and retained by snow retaining fin 180. The length and angle of snow retaining fin 180 is configured to enhance the dwell time of snow thereon which enhances the heat removal capacity of heat exchanger 104. As used herein, the term “positive snow retention angle” refers to a snow retaining fin that has an angle above the horizontal such that snow contacting inner surface 104a adjacent thereto tends to be captured and retained therein resulting in melting snow rather than the snow slide off and thus provides significant heat removal capacity due to the state change of the snow from frozen water to liquid water. In the illustrated embodiment, snow retaining fin 180 has a positive snow retention angle 182 of about sixty degrees.

In addition to snow retaining fin 180, lower arcuate section 176 includes a plurality of additional snow retaining fins including snow retaining fin 184 which represents the uppermost snow retaining fin of lower arcuate section 176. In the illustrated embodiment, snow retaining fin 184 has a positive snow retention angle 186 of about forty-five degrees. From snow retaining fin 184 to snow retaining fin 180, the snow retaining fins of lower arcuate section 176 have progressively increasing positive snow retention angles. More specifically, from snow retaining fin 184 to snow retaining fin 180, the positive snow retention angle of each subsequent snow retaining fin progressively increases by about three degrees. In other embodiments, the snow retaining fins of lower arcuate section 176 could have other configurations including having progressively increasing positive snow retention angles that increase by more or less than three degrees, having snow retaining fins with nonuniformly progressively increasing positive snow retention angles or having snow retaining fins with constant positive snow retention angles. In the illustrated embodiment, each of the snow retaining fins of lower arcuate section 176 including snow retaining fins 180, 184 is configured to enhance the dwell time of snow thereon.

In addition to having positive snow retention angles for the snow retaining fins of lower arcuate section 176, a lower portion 188 of upper arcuate section 172 also has snow retaining fins that have positive snow retention angles. Specifically, for the plurality of snow retaining fins between snow retaining fin 184 and snow retaining fin 190, each has a positive snow retention angle. Similar to the snow retaining fins of lower arcuate section 176, the snow retaining fins of lower portion 188 of upper arcuate section 172 have progressively increasing positive snow retention angles from snow retaining fin 192 to snow retaining fin 194. As such, each of the snow retaining fins of lower portion 188 of upper arcuate section 172 including snow retaining fins 192, 194 is configured to enhance the dwell time of snow thereon. Importantly, as the fluid entering heat exchanger 104 is warmest in first chamber 168a, having snow retaining fins adjacent thereto that have significantly positive snow retention angles enhances the heat removal capacity of heat exchanger 104. Likewise, as the fluid in second chamber 168b is the second warmest, having snow retaining fins adjacent thereto that have positive snow retention angles enhances the heat removal capacity of heat exchanger 104.

In the illustrated embodiment, an upper portion 196 of upper arcuate section 172 has snow retaining fins that have negative snow retention angles wherein the snow retaining fins extend downward and aftward from inner surface 104a and thus have angles below the horizontal. The snow retaining fins of upper portion 196 of upper arcuate section 172 from snow retaining fin 198 to snow retaining fin 200 have progressively increasing snow retention angles. In addition, while the snow retaining fins of upper portion 196 of upper arcuate section 172 have negative snow retention angles, they may nonetheless enhance the dwell time of snow thereon relative to an embodiment in which inner surface 104a entirely lacks snow retaining fins in this region. It is noted that from uppermost snow retaining fin 198 to lowermost snow retaining fin 180 the snow retaining fins have progressively increasing snow retention angles.

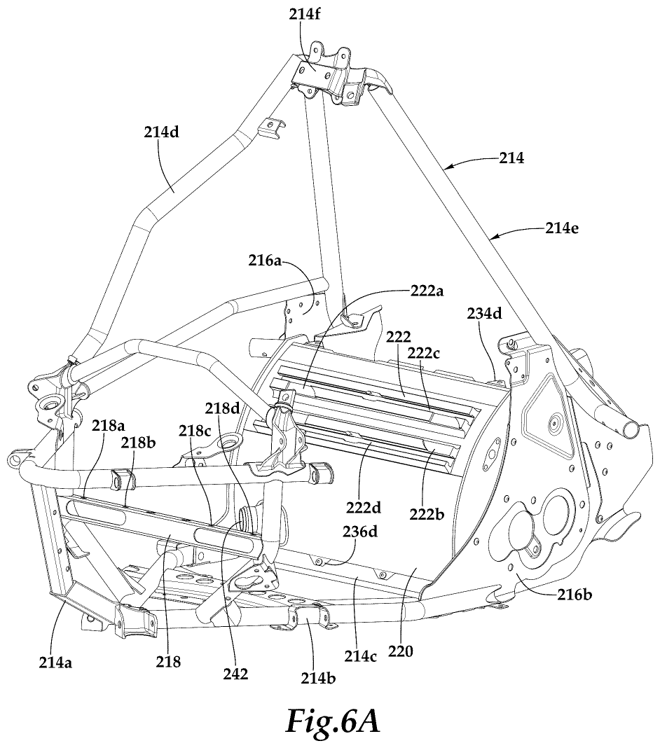

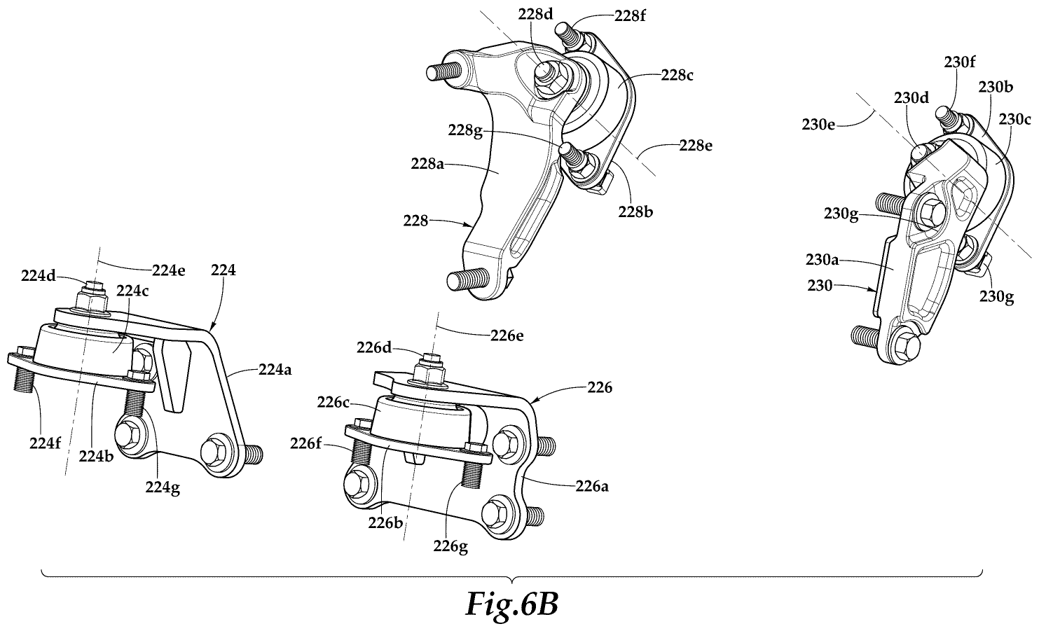

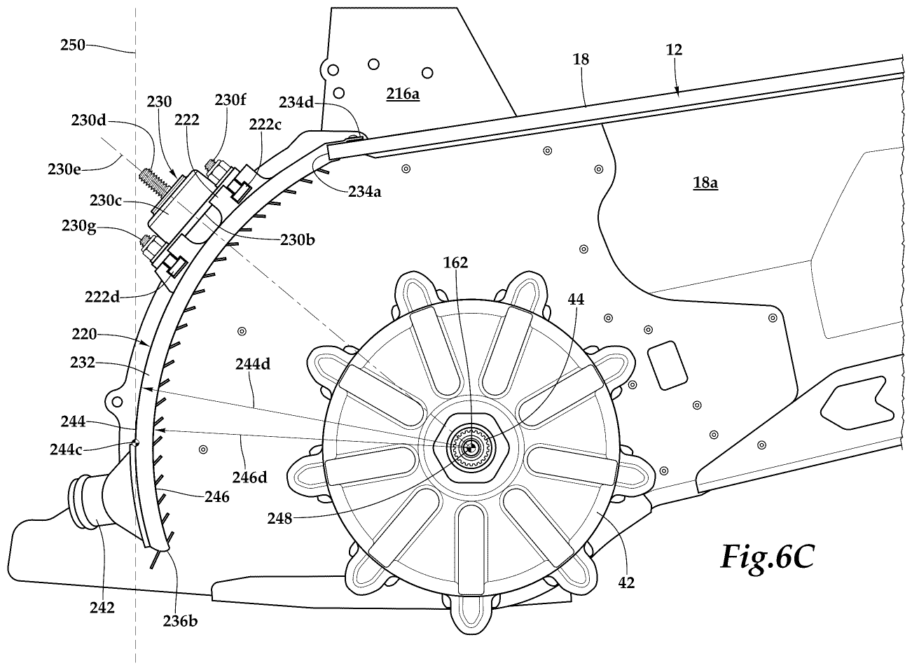

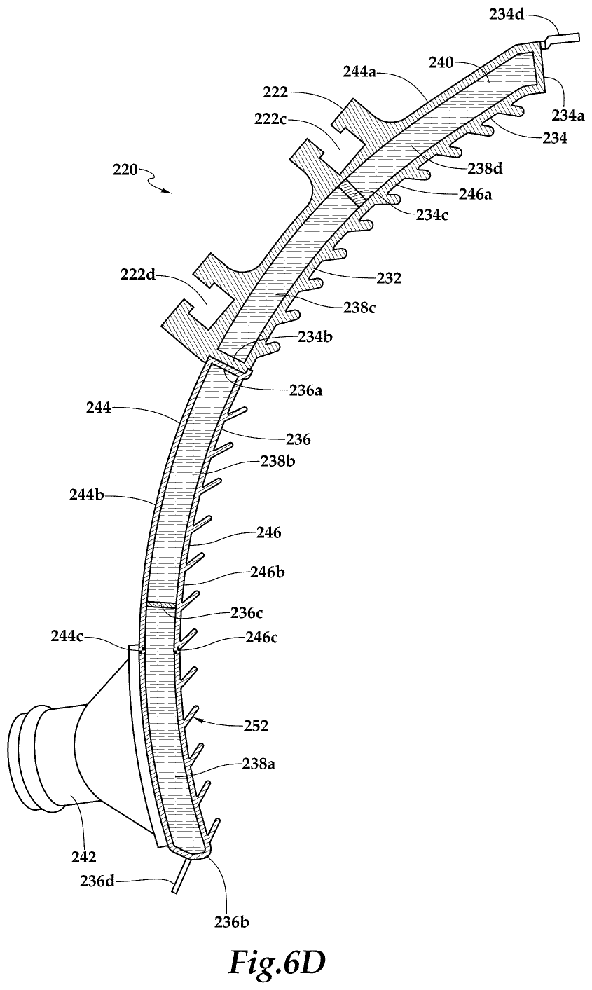

Referring next to FIGS. 6A-6D of the drawings, a heat exchanger incorporating an engine mounting assembly will now be discussed. FIG. 6A depicts a forward frame assembly 214 that is representative of forward frame assembly 14 discussed herein. Forward frame assembly 214 includes nose frame assembly 214a, a base frame assembly 214b including a cross member 214c, which may be a component of a belly pan, a right side frame assembly 214d and a fixed portion of a left side frame assembly 214e as well as a steering column mount 214f. Welded to forward frame assembly 214 are right side plate member 216a and left side plate member 216b. Nose frame assembly 214a includes a nose cross member 218 that includes a pair of right openings 218a, 218b and a pair of left openings 218c, 218d for receiving bolts therethrough that couple the right and left forward engine mounts to nose cross member 218. A heat exchanger 220 is representative of heat exchanger 104 discussed herein. An upper end of heat exchanger 220 is coupled to a forward portion of tunnel 18, the end caps of heat exchanger 220 are coupled to plate members 216a, 216b and a lower end of heat exchanger 220 is coupled to forward frame assembly 14 via cross member 214c. As best seen in FIG. 6D, heat exchanger 220 has a body 232 including an upper housing 234 and a lower housing 236 that may be joined together by welding or other suitable connecting means. Upper housing 234 has an upper end 234a and a lower end 234b. Lower housing 236 has an upper end 236a and a lower end 236b. Upper end 234a includes one or more coupling tabs 234d used to couple heat exchanger 220 to tunnel 18 using rivets or other suitable fasteners. Lower end 236b includes one or more coupling tabs 236d used to couple heat exchanger 220 to base cross member 214c of forward frame assembly 214 using rivets or other suitable fasteners.

Heat exchanger 220 has a plurality of chambers including a first chamber 238a also referred to herein as lowermost chamber 238a, a second chamber 238b, a third chamber 238c and a fourth chamber 238d also referred to herein as uppermost chamber 238d that act as heat exchanger stages. In one example, a heated coolant fluid 240 that has extracted heat from engine 26, enters heat exchanger 220 at a fluid port 242. Fluid 240 enters lowermost chamber 238a in which fluid 240 travels laterally and upwardly through the first stage before entering second chamber 238b in which fluid 240 travels laterally and upwardly through the second stage before entering third chamber 238c in which the fluid travels laterally and upwardly through the third stage before entering uppermost chamber 238d in which the fluid travels laterally and upwardly through the fourth stage before exiting a fluid discharge port (not visible) at upper end 234a and entering, for example, tunnel heat exchanger 106. In other implementations, a heated coolant fluid could instead enter heat exchanger 220 at the upper fluid port then sequentially pass through uppermost chamber 238d, third chamber 238c, second chamber 238b and lowermost chamber 238a before exiting heat exchanger 220 at fluid port 242.

As should understood by those having ordinary skill in the art, fluid port 242 is in fluid communication with lowermost chamber 238a which is in fluid communication with second chamber 238b which is in fluid communication with third chamber 238c which is in fluid communication with uppermost chamber 238d which is in fluid communication with the upper fluid port. In the illustrated embodiment, lowermost chamber 238a and second chamber 238b are positioned within lower housing 236 with third chamber 238c and uppermost chamber 238d positioned within upper housing 234. In other embodiments, a heat exchanger of the present disclosure could have other numbers of chambers both less than and greater than four. Likewise, in other embodiments, an upper housing or a lower housing of a heat exchanger could have other numbers of chambers both less than and greater than two including embodiment in which an upper housing and a lower housing of a heat exchanger have different numbers of chambers.

Body 232 of heat exchanger 220 has a forward wall 244 and an aft wall 246. In the illustrated embodiment, forward wall 244 has an upper section 244a that is formed by upper housing 234 and a lower section 244b that is formed by lower housing 236. Likewise, aft wall 246 has an upper section 246a that is formed by upper housing 234 and a lower section 246b that is formed by lower housing 236. The wall thickness of upper section 244a is greater than the wall thickness of lower section 244b. For example, the thickness of lower section 244b may be between twenty-five and seventy-five percent of the thickness of upper section 244a, such as between forty and sixty percent of the thickness of upper section 244a or about fifty percent of the thickness of upper section 244a. Likewise, the wall thickness of upper section 246a is greater than the wall thickness of lower section 246b. For example, the thickness of lower section 246b may be between twenty-five and seventy-five percent of the thickness of upper section 246a, such as between forty and sixty percent of the thickness of upper section 246a or about fifty percent of the thickness of upper section 246a. The nonuniform thickness of forward wall 244 has the benefit of providing maximum support for engine 26 when engine 26 is mounted to heat exchanger 220 at mounting rails 222. In addition, the nonuniform thickness of aft wall 246 has the benefit of providing maximum heat transfer relative to lowermost chamber 238a and second chamber 238b where coolant fluid 240 is warmest. Forward wall 244 has a forward apex 244c which also represents the forwardmost point of body 232. Aft wall 246 has a forward apex 246c. In the illustrated embodiment, forward apexes 244c, 246c are formed as part of lower housing 246 and are adjacent to lowermost chamber 238a. Upper end 234a is positioned aft and above forward apexes 244c, 246c. In this illustrated embodiment, lower end 236b is positioned aft and below forward apexes 244c, 246c. In other embodiments, lower end 236b could have an aftwardly extending shelf that curves upward for snow retention.

Body 232 of heat exchanger 220 has an arcuate section with a substantially constant radius of curvature and with a center of curvature proximate axis of rotation 162 of track driveshaft 44. The arcuate section may extend the entire length of body 232 from lower end 236b to upper end 234a or may extend for only a portion of the entire length. The arcuate section of body 232 includes an upper portion that extends upward and aftward from forward apexes 244c, 246c and a lower portion that extends downward and aftward from forward apexes 244c, 246c. As best seen in FIG. 6C, forward wall 244 has a substantially constant radius of curvature 244d and aft wall 246 has a substantially constant radius of curvature 246d. Radii of curvature 244d, 246d share a common center of curvature 248 that is coincident with axis of rotation 162 of track driveshaft 44 and track drive sprocket 42.

In this illustrated embodiment, heat exchanger 220 includes an engine mounting assembly depicted as mounting rails 222 that are preferably formed integrally with upper housing 234 using, for example, an extrusion process followed by a machining process. Mounting rails 222 include a right mounting location 222a and a left mounting location 222b may be machined into mounting rails 222 to receive the right and left aftward engine mounts therein. Mounting rails 222 also include upper and lower slots 222c, 222d sized to receive and secure bolt heads therein such that the right and left aftward engine mounts can be coupled thereto. As best seen in FIG. 6B, an engine mount system compatible with mounting rails 222 includes a right forward engine mount 224, a left forward engine mount 226, a right aftward engine mount 228 and a left aftward engine mount 230. In the illustrated embodiments, right forward engine mount 224 includes an angled bracket 224a that is bolted to a forward side of engine 26. A mounting flange 224b with a vibration damper 224c are secured to angled bracket 224a by a bolt 224d. Mounting flange 224b is coupled to nose cross member 218 with bolts 224f, 224g that extend through right openings 218a, 218b to resiliently secure right forward engine mount 224 to nose cross member 218 such that mount axis 224e extends in a direction that is substantially parallel to the aftward tilt angle of engine 26. Left forward engine mount 226 includes an angled bracket 226a that is bolted to a forward side of engine 26. A mounting flange 226b with a vibration damper 226c are secured angled bracket 226a by a bolt 226d. Mounting flange 226b is coupled to nose cross member 218 with bolts 226f, 226g that extend through left openings 218c, 218d to resiliently secure left forward engine mount 226 to nose cross member 218 such that mount axis 226e extends in a direction that is substantially parallel to the aftward tilt angle of engine 26. Due to the resilient nature of vibration dampers 224c, 226c, vibration transfer from engine 26 to nose cross member 218 is reduced and/or eliminated.

Right aftward engine mount 228 has a body 228a that is bolted to an aftward side of engine 26. A mounting flange 228b with a vibration damper 228c is secured to body 228a by a bolt 228d. Mounting flange 228b is coupled to mounting rails 222 by bolts 228f, 228g. Left aftward engine mount 230 has a body 230a that is bolted to an aftward side of engine 26. A mounting flange 230b with a vibration damper 230c is secured to body 230a by a bolt 230d. Mounting flange 230b is coupled to mounting rails 222 by bolts 230f, 230g. As best seen in FIG. 6C, the head of bolt 230f is received within upper slot 222c and the head of bolt 230g is received within lower slot 222d with mounting flange 230b received within left mounting location 222b. In this configuration, mounting flange 230b is secured to mounting rails 222 with bolts 230f, 230g such that mount axis 230e extends through heat exchanger 220 in a radial direction relative to axis of rotation 162 of track driveshaft 44. Likewise, when mounting flange 228b is secured to mounting rails 222 within right mounting location 222a with bolts 228f, 228g, mount axis 228e extends through heat exchanger 220 in a radial direction relative to axis of rotation 162 of track driveshaft 44 (not visible). In the illustrated embodiment, the recessed shape of mounting locations 222a, 222b conform to the shape of mounting flanges 228b, 230b to properly locate and retain mounting flanges 228b and 230b therein during fastening of mounting flanges 228b, 230b mounting rails 222. Due to the resilient nature of vibration dampers 228c, 230c, vibration transfer from engine 26 to heat exchanger 220 is reduced and/or eliminated. In the illustrated embodiment, vibration dampers 228c, 230c are positioned aft of a plane 250 that is tangent to forward apex 244c and lower end 236b is positioned aft of at least a portion of vibration dampers 228c, 230c.

In the illustrated embodiments, mounting rails 222 are located on the forward side of upper housing 234 such that mounting rails 222 are closer to upper end 234a than lower end 236b. Mounting rails 222 extend the lateral direction of snowmobile 10 and have a length that is more than half the lateral length of heat exchanger 220 and, in the illustrated embodiment, have a length of about ninety percent of the lateral length of heat exchanger 220. Disposed within upper housing 234 is a partition 234c that extends between forward wall 244a and aft wall 246a and includes one or more fluid passageways to allow fluid communication between uppermost chamber 238d and third chamber 238c. Partition 234c not only divides upper housing 234 to form uppermost chamber 238d and third chamber 238c but also provides reinforcement for mounting rails 222 as partition 234c sits behind the upper set of rails thus providing added support for engine 26. Lower end 234b also provides reinforcement for mounting rails 222 as lower end 234b sits behind the lower set of rails thus providing added support for engine 26. Lower end 234b includes one or more fluid passageways that are aligned with one or more fluid passageways of upper end 236a of lower housing 236 to allow fluid communication between second chamber 238b and third chamber 238c. Disposed within lower housing 236 is a partition 236c that extends between forward wall 244b and aft wall 246b and includes one or more fluid passageways to allow fluid communication between second chamber 238b and lowermost chamber 238a. In the illustrated embodiments, fluid port 242 is located on the forward side of lower housing 236 and extends in a forward and downward direction relative to forward wall 244b.

As discussed herein, the arcuate section of body 232 may extend the entire length of body 232 from lower end 236b to upper end 234a or may extend for only a portion of the entire length. For example, the arcuate section of body 232 may extend from lower end 236b to at least the uppermost part of mounting rails 222. The arcuate section of body 232 may extend from lower end 236b to at least mount axis 230e of vibration damper 230c of left aftward engine mount 230. The arcuate section of body 232 may extend from lower end 236b to at least the lowermost part of mounting rails 222. In additional examples, the arcuate section of body 232 may extend at least between fluid port 242 and upper end 234a. The arcuate section of body 232 may extend at least between fluid port 242 and the uppermost part of mounting rails 222. The arcuate section of body 232 may extend at least between fluid port 242 and mount axis 230e of vibration damper 230c of left aftward engine mount 230. The arcuate section of body 232 may extend at least between fluid port 242 and the lowermost part of mounting rails 222.

Heat exchanger 220 has a plurality of snow retaining fins 252 that extends aftward from aft wall 246. The snow retaining fin 252 that are adjacent to lowermost chamber 238a, second chamber 238b and third chamber 238c each have a positive snow retention angle configured to enhance the dwell time of snow thereon. In the illustrated embodiment, snow retaining fins 252 have a progressively increasing positive snow retention angle from the uppermost snow retaining fin 252 of third chamber 238c to the lowermost snow retaining fin 252 of lowermost chamber 238a. The snow retaining fin 252 that are adjacent to uppermost chamber 238d have a negative snow retention angle configured to enhance the dwell time of snow thereon. In the illustrated embodiment, snow retaining fins 252 have a progressively increasing snow retention angle from the uppermost snow retaining fin 252 of uppermost chamber 238d to the lowermost snow retaining fin 252 of uppermost chamber 238d.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. An engine cooling system for a snowmobile including a forward frame assembly, an engine, a tunnel and a track driveshaft having an axis of rotation, the cooling system comprising:
a heat exchanger coupled to the forward frame assembly and to the tunnel, the heat exchanger positioned aft of the engine and configured to transfer heat from a coolant fluid circulated through the engine and the heat exchanger;
wherein, the heat exchanger includes a body having an arcuate section with a substantially constant radius of curvature and with a center of curvature proximate the axis of rotation of the track driveshaft.

2. The cooling system as recited in claim 1 wherein, the body has a forward wall, an aft wall, an upper end and a lower end, the forward and aft walls each having a forward apex; and
wherein, the arcuate section includes an upper portion extending upward and aftward from the forward apexes and a lower portion extending downward and aftward from the forward apexes.

3. The cooling system as recited in claim 2 wherein, the upper end is coupled to the tunnel and the lower end is coupled to the forward frame assembly.

4. The cooling system as recited in claim 2 wherein, the lower end is positioned aft of the forward apex of the aft wall.

5. The cooling system as recited in claim 2 wherein, the heat exchanger includes an engine mounting assembly positioned on the forward wall, the engine mounting assembly located closer to the upper end than the lower end; and
wherein, the arcuate section of the body extends from the lower end to at least the engine mounting assembly.

6. The cooling system as recited in claim 2 wherein, the heat exchanger includes a lowermost chamber disposed within the lower portion of the arcuate section; and
wherein, the heat exchanger includes a fluid port positioned on the forward wall and in fluid communication with the lowermost chamber.

7. The cooling system as recited in claim 6 wherein, the fluid port extends forward and downward from the forward wall.

8. A snowmobile comprising:
a forward frame assembly;
a tunnel coupled to the forward frame assembly;
a drive track system disposed at least partially below the tunnel, the drive track system including a track driveshaft having an axis of rotation; and
a heat exchanger having a body with a forward wall, an aft wall, an upper end and a lower end, the upper end coupled to the tunnel, the lower end coupled to the forward frame assembly, the heat exchanger including an engine mounting assembly positioned on the forward wall between the upper and lower ends;
wherein, the body has an arcuate section with a substantially constant radius of curvature and with a center of curvature proximate the axis of rotation of the track driveshaft, the arcuate section extending from the lower end of the body to at least the engine mounting assembly.

9. The snowmobile as recited in claim 8 wherein, the heat exchanger defines at least first and second chambers with a partition therebetween; and
wherein, the partition extends between the forward wall and the aft wall behind the engine mounting assembly.

10. The snowmobile as recited in claim 9 wherein, the body includes an upper housing that defines the first and second chambers, the engine mounting assembly integrally formed with the upper housing.

11. The snowmobile as recited in claim 8 wherein, the body has a length in the lateral direction of the snowmobile; and
wherein, the engine mounting assembly further comprises mounting rails having a length in the lateral direction of the snowmobile that is more than half the length of the body.

12. The snowmobile as recited in claim 8 further comprising a vibration damper having a mount axis that extends through the body, the vibration damper coupled to the engine mounting assembly;
wherein, the arcuate section of the body extends from the lower end of the body to at least the mount axis of the vibration damper.

13. The snowmobile as recited in claim 12 wherein, the mount axis of the vibration damper extends in a radial direction of the track driveshaft.

14. A snowmobile comprising:
a forward frame assembly;
a tunnel coupled to the forward frame assembly;
a drive track system disposed at least partially below the tunnel, the drive track system including a track driveshaft having an axis of rotation; and
a heat exchanger having a body including an upper housing with an upper end and a lower housing with a lower end, the upper end coupled to the tunnel, the lower end coupled to the forward frame assembly, the heat exchanger including an engine mounting assembly positioned on a forward side of the upper housing and a fluid port positioned on a forward side of the lower housing;
wherein, the body has an arcuate section with a substantially constant radius of curvature and a center of curvature proximate the axis of rotation of the track driveshaft, the arcuate section extending at least between the fluid port and the engine mounting assembly.

15. The snowmobile as recited in claim 14 wherein, the upper housing has a forward wall having a first thickness; and
wherein, the lower housing has a forward wall having a second thickness that is less than the first thickness.

16. The snowmobile as recited in claim 14 wherein, the body has a forward apex;
wherein, the upper end is positioned aft and above the forward apex; and
wherein, the lower end is positioned aft and below the forward apex.

17. The snowmobile as recited in claim 16 wherein, the forward apex is located on the lower housing.

18. The snowmobile as recited in claim 17 further comprising a vibration damper coupled to the engine mounting assembly;
wherein, the vibration damper is positioned aft of a plane that is tangent to the forward apex.

19. The snowmobile as recited in claim 18 wherein, the lower end is positioned aft at least a portion of the vibration damper.

20. The snowmobile as recited in claim 14 further comprising a vibration damper having a mount axis that extends through the body, the vibration damper coupled to the engine mounting assembly;
wherein, the arcuate section of the body extends at least between the fluid port and the mount axis of the vibration damper.
